(19) United States
(12) Patent Application Publication
(10) Pub. No.: US 2007/0050987 A1
(43) Pub. Date: Mar. 8, 2007

(54) Articulated spoon

(76) Inventor: Maria Del Pilar Cervantes, Fullerton, CA (US)

Correspondence Address: WALTER A, HACKLER, Ph.D.;PATENT LAW OFFICE, SUITE B, 2372 S.E. BRISTOL STREET, NEWPORT BEACH, CA, 92660-0755, US

(21) Appl. No.: 11/220,498

(22) Filed: Sep. 7, 2005

(51) Int. Cl. A47J 43/28

(52) U.S. Cl. 30/150

(57) ABSTRACT

An eating/feeding utensil includes a head along with a handle interconnected therewith. An articulation is provided for separating the handle into two segments with the first segment being fixed to the head and the second segment having a length suitable for manual manipulation. The articulation enables the first and second segments to be adjustably disposed at an angle to one another in order to facilitate self or aided feeding of an individual.

The present invention is generally directed to eating utensils and is more particularly directed to a spoon or a fork for challenged, disabled, autistic, or aged individuals.

Children and adults have difficulty and frustration of not having or losing the ability to feed themselves. In adults, this condition can be the result of Parkinson's disease, Alzheimer's, arthritis, neurological impairments, or stroke.

In the case of an individual who is unable to feed himself/herself reliance must be placed on either a caregiver, parent, or nurse. The present invention provides for utensil which enables a disabled individual to feed himself or facilitates the feeding of the individual by a caregiver.

### SUMMARY OF THE INVENTION

An eating/feeding utensil in accordance with the present invention generally includes a head, which may comprise either a fork or a spoon, along with a handle connected thereto.

Specifically, the handle is separated by an articulation into two segments with a first segment fixed to the head and a second segment having a length suitable for manual manipulation. This articulation enables the first and second segments to be adjustably disposed at an angle to one another to facilitate use thereof and further the articulation may provide for a greater than a 180° angle. Thus, the utensil is adaptable for use for both right and left-handed people.

When articulated, the handle, including the first and second segments, lies in a single plane which facilitates use of the utensil. The articulation may include means for releasably fixing the first and second segments at various angles with respect to one another. Such angles may be between minus and plus 180° or more as desired.

At least one of these various angles is zero, in which the segments are aligned with one another in order to facilitate hand or machine sterilization thereof. In the linear configuration, multiple utensils will align themselves, thus facilitating cleaning/sterilization thereof.

Preferably, the articulation comprises mating radial ribs disposed respectively on engaging ends of the first and second segments and a spring may be utilized for causing biased engagement between the radial ribs of the first and second segments in order to provide a stable articulation at a desired angle.

A screw may be provided for removably attaching the first and second segments to one another and to further facilitate cleaning, means may be provided for separating the mating radial ribs when the angle between the first and second segment is zero, i.e. when the segments are aligned, to facilitate fluid or a steam cleaning of the articulation.

### BRIEF DESCRIPTION OF THE DRAWINGS

The advantages and features of the present invention will be better understood with reference to the following detailed description when considered in conjunction with the accompanying drawings of which:

FIG. 1 is a plan view of the eating/feeding utensil in accordance with the present invention showing a head along with a handle connected thereto and an articulation separating the handle into two segments with the first segment fixed to the head and the second segment having a length suitable for manual manipulation, the segments shown articulated in bold line at one angle and in dashed line at another angle illustrating a feature of the utensil which provides for use by right and left handed individuals;

FIG. 2 is a plan view of the utensil shown in FIG. 1 showing the first and second segments aligned with one another to facilitate cleaning along with other utensils (not shown);

FIG. 3 is a side view of the utensil in accordance with the present invention more particularly showing means for separating the ribs of the articulation to promote sterilization;

FIG. 4 is an enlarged view of the articulation illustrating ribs along with a spring for causing biased engagement between the radial ribs and a screw interconnecting the articulation;

FIG. 5 is a view taken along lines 5-5 of FIG. 1; and

FIG. 6 is a view taken along lines 6-6 of FIG. 2.

### DETAILED DESCRIPTION

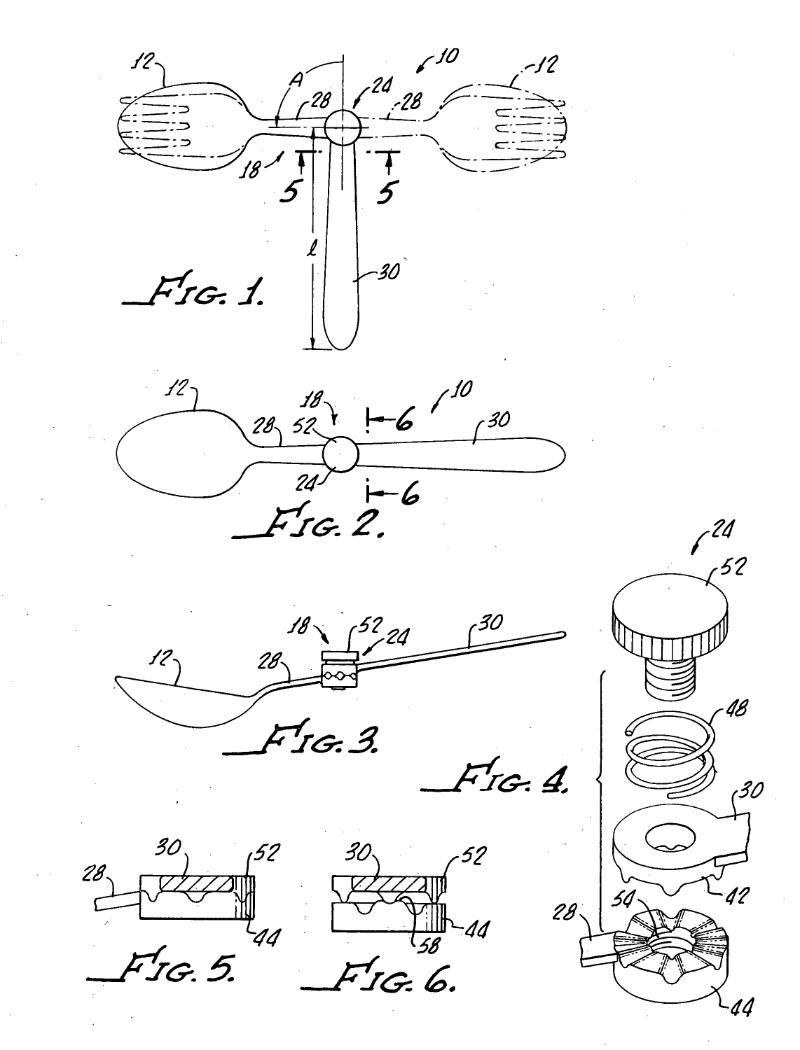

With reference now to FIGS. 1-2, there is shown an eating/feeding utensil 10 in accordance with the present invention generally including a head 12 which may include a spoon, shown in solid line, or a fork, shown in dashed line along with a handle 18 connected to the head 12, the head 12 and handle 18 being formed from a common material such as metal or plastic suitable for cleaning by hand or dishwasher, or other sterilization machines.

As illustrated in FIGS. 1-2 and more particularly in FIGS. 3-6, an articulation 24 is provided which separates the handle 18 into two segments 28, 30, a first segment 28 fixed to the head 12 and a second segment 30 having a length 1, suitable for manual manipulation by either a disadvantaged individual or a care giver.

The articulation 24 enables the first and second segments 28, 30 to be adjustably disposed at an angle A which may be from more than minus 90° to more than plus 90°, the positions being illustrated in FIG. 1 by bold and broken lines.

As hereinabove noted, this configuration of facilitates of the utensil 10 by both right and left-handed individuals.

Use of the utensil 10 may enable individuals to eat by themselves and certainly facilitates feeding by a caregiver which in turn creates and fosters positive psychological effects for both the users and the care providers.

When used by an individual, the utensil may also increase hand/eye coordination, muscle tone, and proprioceptive function. These features are facilitated by the fact that the first and second segments 28, 30 lie in a plane 34, see FIG. 3 when aligned or articulated.

To facilitate cleaning and alignment of the utensil with other fixed utensils (not shown) or companion utensils 10, the segments 28, 30 may be aligned as shown in FIG. 2.

With more particular reference to FIGS. 3-6, the articulation 24 may include mating radial ribs 38 disposed respectively on engaging ends 42, 44 biased against one another by a spring 48 and assemble through the use of a screw 52 and threads 54.

As shown in FIGS. 4-6, a flat area 58 provides means for separating the segment ends 42, 44 when the segments 28, 30 are aligned with one another to facilitate the passage of cleaning fluid or vapor therebetween during cleaning.

Although there has been hereinabove described a specific articulated spoon in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. An eating/feeding utensil comprising:
a head;
a handle connected to said head; and
an articulation separating said handle into two segments, a first segment fixed to said head and a second segment having a length suitable for manual manipulation, said articulation enabling the first and second segments to be adjustably disposed at an angle to one another.

2. The utensil according to claim 1 wherein the head and handle including the first and second segment and lie in a plane when articulated.

3. The utensil according to claim 2, wherein said articulation comprises means for releasably fixing the first and second segments at various angles with respect to one another.

4. The utensil according to claim 3 wherein at least one of the various angles is zero to facilitate linear alignment of the utensil with other utensil for machine sterilization thereof.

5. The utensil according to claim 4 wherein said articulation comprises mating radial ribs disposed respectively on engaging ends of the first and second segments.

6. The utensil according to claim 5 further comprises a spring for causing biased engagement between the radial ribs of the first and second segments.

7. The utensil according to claim 6 further comprises screw means for removably attaching the first and second segment to one another.

8. The utensil according to claim 5 further comprising means for separating the mating radial ribs when the various angle is zero to facilitate sterilization between the ribs.

9. The utensil according to claim 8 wherein said head comprises a spoon.

10. The utensil according to claim 8 wherein said head comprises a fork.

11. An eating/feeding utensil comprising:
a head;
a handle connected to said head;
an articulation separating said handle into two segments, a first segment fixed to said head and a second segment having a length suitable for manual manipulation, said articulation enabling the first and second segments to be adjustably disposed at an angle to one another; and
means for separating the articulation when the adjustable angle is zero to facilitate sterilization of the articulation.

12. The utensil according to claim 11 wherein the head and handle including the first and second segment and lie in a plane when articulated.

13. The utensil according to claim 12, wherein said articulation comprises means for releasably fixing the first and second segments at plus or minus 90° angles or more with respect to one another.

14. The utensil according to claim 13 wherein said articulation comprises mating radial ribs disposed respectively on engaging ends of the first and second segments.

15. The utensil according to claim 14 further comprises a spring for causing biased engagement between the radial ribs of the first and second segments.

16. The utensil according to claim 15 further comprises screw means for removably attaching the first and second segment to one another.

17. The utensil according to claim 11 further comprising means for separating the mating radial ribs when the various angle is zero to facilitate sterilization between the ribs.

18. The utensil according to claim 17 wherein said head comprises a spoon.

19. The utensil according to claim 17 wherein the head comprises a fork.
